(19) United States
(12) Patent Application Publication
(10) Pub. No.: US 2023/0135743 A1
(43) Pub. Date: May 4, 2023

(54) SYSTEM AND METHOD TO RESIST MOTION OF HUMAN POWERED VEHICLES

(71) Applicant: GoSlo, LLC, Atlanta, GA (US)

(72) Inventors: John Tyler Tatum, Atlanta, GA (US); Ronnie Jack Garmon, Jasper, GA (US); Benjamin Jason Emley, Houston, TX (US); Suyash Rajesh, Kennesaw, GA (US)

(21) Appl. No.: 17/979,371

(22) Filed: Nov. 2, 2022

Related U.S. Application Data
(60) Provisional application No. 63/275,203, filed on Nov. 3, 2021.

(51) Int. Cl. A63B 69/16; A63B 21/00; A63B 24/00

(52) U.S. Cl. CPC A63B 69/16; A63B 21/00192; A63B 24/0062; A63B 2209/08; A63B 2220/58

(57) ABSTRACT

Disclosed are various embodiments directed toward applying a magnetic resistance to a human powered vehicle during movement. In various embodiments, magnets are placed within receptacles of magnet holding brackets and are exposed to one or more conducting discs that are configured to spin with the wheels of the human powered vehicle. The magnetic field of the magnets that intersect the conducting discs can generate a force that opposes the movement of the human powered vehicle. In various embodiments, the magnet holding brackets are adjustable based on desired wattage values.

### CROSS-REFERENCE TO RELATED APPLICATIONS

This application claims priority to, and the benefit of, U.S. Provisional Patent Application No. 63/275,203, filed on Nov. 3, 2021, and titled “SYSTEM AND METHOD TO RESIST MOTION OF HUMAN POWERED VEHICLES,” which is incorporated by reference herein in its entirety.

### BACKGROUND

Since the inception of human powered vehicles such as bicycles, the cycling world has focused on certain objectives: decreasing the weight of the bicycle, increasing the speed of the bicycle, and decreasing the effort required to maintain the speed of the bicycle. Human powered vehicles have also been developed to operate in a stationary manner to allow the cyclist to exercise in place.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 shows an example of a system that can magnetically add or reduce resistance to a pedaling mechanism of a human powered vehicle according to various embodiments of the present disclosure.

FIG. 2 shows another example of a system that can magnetically add or reduce resistance to a pedaling mechanism of a human powered vehicle according to various embodiments of the present disclosure.

FIG. 3 shows another example of a system that can magnetically add or reduce resistance to a pedaling mechanism of a human powered vehicle according to various embodiments of the present disclosure.

FIG. 4 shows an example of a static magnet holding bracket illustrated in FIG. 1 according to one embodiment of the present disclosure.

FIG. 5 shows one example of a static magnet holding bracket illustrated in FIG. 4 according to one embodiment of the present disclosure.

FIG. 6 shows an adjustable magnet holding bracket illustrated in FIG. 2 according to one embodiment of the present disclosure.

FIG. 7 shows one example an adjustable magnet holding bracket of FIG. 3 according to one embodiment of the present disclosure.

FIG. 8 shows another example of an adjustable magnet holding bracket of FIG. 3 according to one embodiment of the present disclosure.

FIG. 9 shows a portion of the adjustable magnet holding bracket of FIG. 8 according to one embodiment of the present disclosure.

FIG. 10 shows another example of an adjustable magnet holding bracket of FIG. 3 according to one embodiment of the present disclosure.

FIG. 11 shows another example of an adjustable magnet holding bracket of FIG. 3 according to one embodiment of the present disclosure.

FIG. 12 shows a schematic block diagram of a computing device according to various embodiments of the present disclosure.

FIGS. 13 and 14 are flowcharts illustrating examples of functionality implemented as portions of a control system executed in the computing device of FIG. 12 according to various embodiments of the present disclosure.

### DETAILED DESCRIPTION

According to various embodiments, systems and methods are set forth herein that facilitate providing for static and variable wattage consumption when riding a human powered vehicle such as a bicycle. Various embodiments are set forth that allow for the addition of a static resistance to the wheels of the human powered vehicle that require a rider to apply a greater wattage to propel the vehicle forward. In other embodiments, the resistance created can vary over time in accordance with a desired wattage. Such desired wattage may be selected by a rider, obtained from a predefined wattage per distance file, or the desired wattage may be specified in some other manner. According to one embodiment, the resistance applied to a pedaling mechanism of a moving bicycle is accomplished by the use of magnets as will be described.

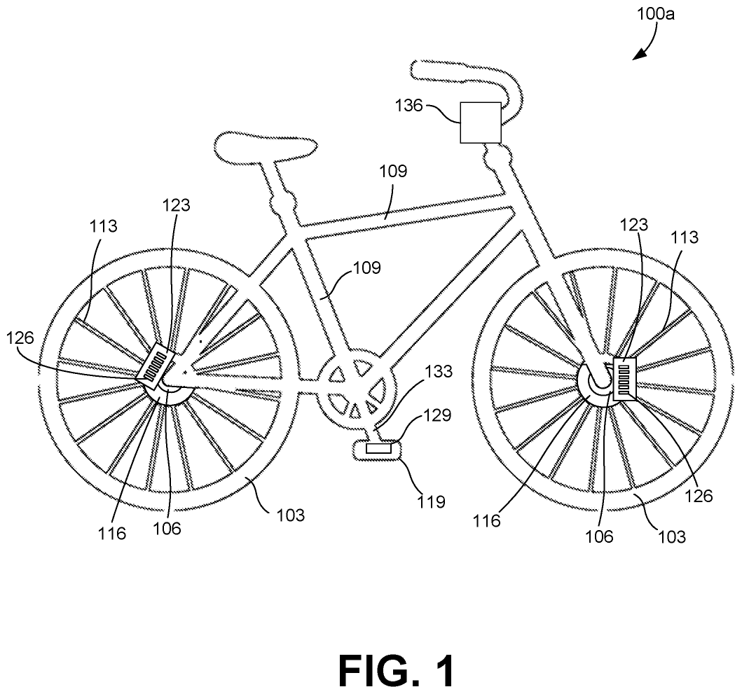

With reference to FIG. 1, shown is an illustration of a human powered vehicle 100a that comprises, for example, a bicycle. Although the human powered vehicle 100a is shown as a bicycle, it is understood that the human powered vehicle 100a may comprise other types of vehicles such as unicycles, tricycles, quadracycles, or other vehicles. Furthermore, assuming the human powered vehicle 100a is a bicycle, then it may comprise road bicycles, mountain bicycles, hybrid bicycles, recumbent bicycles, touring bicycles, and other bicycles.

The human powered vehicle 100a includes front and rear wheels 103 that spin about an axle. Each wheel 103 includes a hub 106. Each axle fits through a respective one of the hubs 106 and connects to a frame 109. In various embodiments, the central hubs 106 are core portions of the wheels 103, and each of the central hubs 106 includes a set of bearings around which one of the wheels 103 rotates. A number of front or rear spokes 113 connect the rims of the wheels 103 to the hubs 106.

In order to magnetically add or reduce resistance to the human powered vehicle 100a while moving, according to various embodiments, the human powered vehicle 100a includes front and rear conducting discs 116 that are connected to the front and rear wheels 103, respectively, via the central hubs 106. The conducting discs 116 are fixed to the wheels by way of the hubs 106 or other structure so as to spin around the axles along with the wheels 103. As such, the conducting discs 116 spin or rotate along with the wheels about the rotational axes of the wheels 103 when a cyclist engages the pedals 119 or other structure to generate force to move the human powered vehicle 100a.

Also, the human powered vehicle 100a includes one or more magnet holding brackets 123 that are attached to the frame 109. As shown, the magnet holding brackets 123 are positioned adjacent to or near each of the conducting discs 116. The magnet holding brackets 123 hold one or more magnets 126. In the various embodiments, the magnets 123 may comprise a permanent magnet, an electromagnet, or other type of magnetic material.

Although the human powered vehicle 100a is shown in FIG. 1 as including both the front and the rear conducting discs 116 and their corresponding magnet holding brackets 123, other embodiments may include only a single conducting disc 116/magnet holding bracket 123 on one of the wheels 103. To this end, there may be one or more conducting discs 116 and corresponding magnet holding brackets 123 on a given human powered vehicle 100a limited by the total number of wheels or configurations employed. For example, it may be possible to link multiple magnet holding brackets 123 on a single wheel such as on both sides of a wheel or at different locations on the wheel as will be described.

In various embodiments, the conducting discs 116 can be composed of copper, aluminum, steel, or any other conducting metal, or any combination of one or more such conducting metals. The conducting discs 116 may comprise a solid disc or the conducting discs 116 may have voids. For example, in one embodiment, the conducting discs 116 may be a ring with spokes. In one approach, the conducting discs 116 may replace a friction brake disc in a conventional bicycle.

To magnetically apply resistance to the pedaling mechanism of the human powered vehicle 100a, the conducting discs 116 are exposed to one or more magnets that can be placed in receptacles (not shown) of the magnet holding brackets 123. In some embodiments, the magnet holding brackets 123 can be fixedly attached to the frame 109 through bolts, clamps, weld adhesives, screws, or other means of attachments. The magnet holding brackets 123 are positioned on the human powered vehicle 100a relative to the conducting discs 116 so that a magnetic field of the magnets placed in the static magnet holding bracket 123 intersects with the conducting discs 116. As a rider rides the human powered vehicle 100a, the conducting discs 116 rotate, and eddy currents are induced in the conducting discs 116 by way of electromagnetic induction given that the magnetic fields of the magnets intersect with the conducting discs 116. The configuration of FIG. 1 shows a static version of a magnet holding bracket 123 such that it does not move and the magnets 126 positioned on the magnet holding bracket 123 are maintained in a static position relative to the conducting disc 116 when either at rest or in motion.

The eddy currents produce a counter electromagnetic field that opposes the magnetic field of the magnets. As a result, the conducting discs 116 experience a drag force from the magnets 126 that opposes their rotation. The magnitude of the force that opposes the rotation of the conducting discs 116 depends on the size of the conducting disc 116, the number of magnets or magnitude of the magnetic flux that intersects with the conducting disc 116, the rotational velocity of the conducting disc 116, and on other factors.

Accordingly, the eddy currents produced on the conducting discs 116 oppose rotation of the wheels 103 and, correspondingly, increase the resistance experienced by a rider of the human powered vehicle 100a, thereby making pedaling more difficult for the rider. As the embodiments discussed by way of FIG. 1 relate to a passive system with static magnet holding brackets 123, once the magnets 126 are placed in the static magnet holding brackets 123, the positioning of the magnets 126 generally may not be changed unless the cyclist stops the human powered vehicle 100a and manually changes the position of the magnets 126 on the magnet holding bracket(s) 123, or removes the magnets 126 from the magnet holding bracket(s) 123. However, in other embodiments, active systems may be employed in which the positioning of the magnets 126 relative to the conducting discs 116 can be changed dynamically while the human powered vehicle is moving as will be described.

The passive system embodiments described above can be useful for a cyclist who wishes to train with a certain level of added resistance. Additionally, the passive system embodiments described above can be useful for a cyclist who does not need to vary the amount of resistance added during the training session. For example, a cyclist may be training for a race or a meet but may only be able to train on flat terrain. Training on flat terrain may provide inadequate preparation for a race. For example, without the added magnetic resistance, the cyclist may exert an average power output of 250 watts during a training session on the flat terrain averaging a certain velocity. However, the cyclist may wish to exert an average power output of 300 watts on the same flat terrain while averaging a similar velocity. To achieve this, the cyclist can place magnets into the front static magnet holding bracket 123 and/or rear static magnet holding bracket 123 and then begin a training session. The cyclist, on the flat terrain, will need to generate more power to maintain a predefined velocity with the magnets 126 in place, thereby experiencing a workout with a higher level of exertion than a workout without use of the magnets 126.

To give another example, a cyclist may wish to train at a lower velocity while maintaining a similar exertion level in trials or paths, for example, where other traffic such as pedestrians may exist or where a rider wishes to train with a partner with lesser ability. Accordingly, the rider can add magnets 126 to one or more magnet holding brackets 123 which will require the rider to maintain a desired level of exertion while training at a slower velocity.

To gauge the power exerted, the human powered vehicle 100a includes a power meter 129, which is a device that can measure a cyclist's average power output or exertion level, during a cycling session in terms of watts. In various embodiments, the power meter 129 can measure instantaneous power output, average power output over a duration of time, or a total power output exerted over a certain distance. Although FIG. 1 illustrates the power meter 129 being placed on the pedal 119 of a human powered vehicle 100a comprising a bicycle, the power meter 129 can be placed on other various parts of the human powered vehicle 100a such as the crank arm 133 or the central hubs 106. The power meter 129 may employ strain gauges to measure applied torque and, when combined with angular velocity, can calculate power output in terms of watts. In various embodiments, the power meter 129 is communicatively coupled to a computing device 136 through WiFi, Bluetooth®, near-field communication (NFC), radio-frequency identification (RFID), wireless infrared, ultra-wideband, wireless induction, long range (LoRa), Z-Wave®, ZigBee®, and other wireless communication methods. The computing device 136 may include a display device that displays, among other information, the watts generated by the rider at a given instant. Accordingly, a cyclist can view his or her power output in real time through a display of the computing device 136.

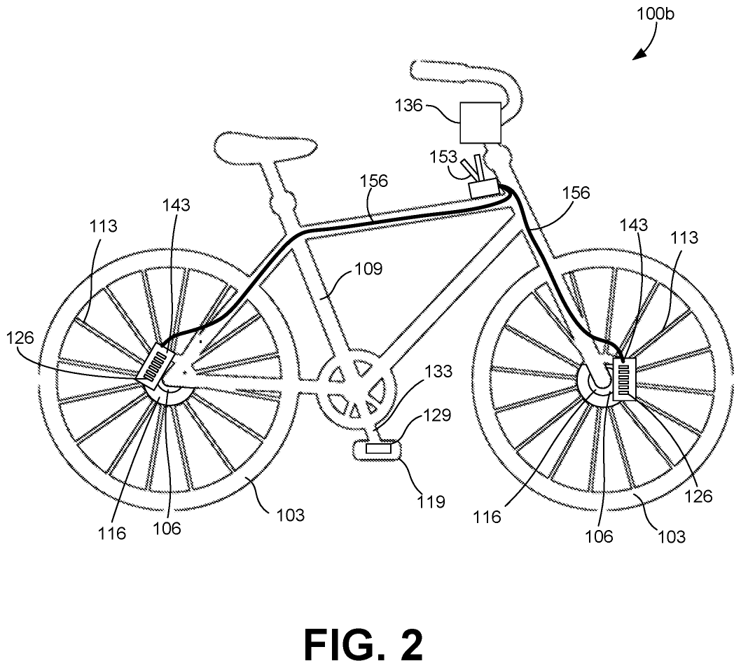

Referring next to FIG. 2, shown is an illustration of human powered vehicle 100b according to an embodiment of the present disclosure. The human powered vehicle 100b includes many of the same components as the human powered vehicle 100a (FIG. 1) except as set forth in the description below, where like components are denoted with the same reference numbers.

The human powered vehicle 100b further includes adjustable magnet holding brackets 143 that are positioned adjacent to the conducting discs 116. Each of the adjustable magnet holding brackets 143 is linked to levers 153 by way of a cable 156. Each cable 156 includes, for example, an inner cable (not shown) and a housing (not shown). In some embodiments, a housing may not be used at least along portions of the cable 156.

Each of the adjustable magnet holding brackets 143 provides for movement of the magnets 126 relative to one or two sides of a respective conducting disc 116. Specifically, the adjustable magnet holding brackets 143 facilitate movement of the magnets 126 away from and closer to a respective conducting disc 116. As one or more magnets 126 are moved closer to a side of a given conducting disc 116, the density of the magnetic field of the magnet 126 that intersects with conducting disc 116 increases. Conversely, as the one or more magnets 126 are moved away from a side of a given conducting disc 116, the density of the magnetic field of the magnet 126 that intersects with the conducting disc 116 decreases.

The cables 156 are attached to the levers 153 and transfer force generated by the levers 153 into movement or adjustment of the adjustable magnet holding brackets 143 such that the magnets 126 held by the adjustable magnet holding brackets 143 are moved away from or closer to the conducting disc 116. In this manner, a rider of the human powered vehicle 100b can control the amount of force generated by virtue of eddy currents in the conducting discs 116 by positioning a respective lever 153, thereby moving the magnets closer to or away from a respective conducting disc 116. The force that opposes the movement of the human powered vehicle 100b can be manually adjusted accordingly. According to one embodiment, a rider can see the watts consumed on a display device 136 of the computing device 136 and can position one or more levers 153 to create more or less force opposing the movement of the human powered vehicle 100b such that a desired wattage is maintained. The functionality of how a given adjustable magnet holding bracket 143 moves magnets 126 relative to a conducting disc 116 is described with respect to later figures.

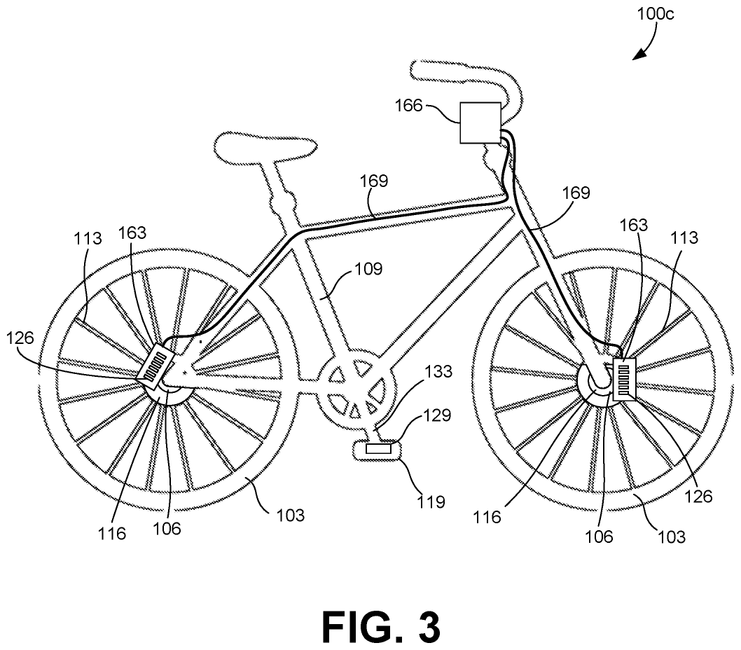

Referring next to FIG. 3, shown is an illustration of human powered vehicle 100c according to an embodiment of the present disclosure. The human powered vehicle 100c includes many of the same components as the human powered vehicles 100a (FIG. 1) and 100b (FIG. 2) except as set forth in the description below, where like components are denoted with the same reference numbers.

The human powered vehicle 100c includes adjustable magnet holding brackets 163. According to one embodiment, the adjustable magnet holding brackets 163 include electric components or other components such as, for example, linear or rotary actuators that cause adjustment of the adjustable magnet holding brackets 163, thereby moving the magnets 126 held by the adjustable magnet holding brackets 163 closer to or away from the conducting discs 116. Alternatively, the adjustable magnet holding brackets 163 may include electromagnets that generate a variable magnetic field as will be discussed.

The human powered vehicle 100c includes a computing device 166 that facilitates control of the adjustable magnet holding brackets 163 as will be described. The computing device 166 is connected to actuators on the adjustable magnet holding brackets 163 by way of wires 169.

The computing device 166 is configured to execute a control system (not shown) that controls the positioning of magnets 126 relative to the conducting discs 116 to generate a force that opposes the movement of the human powered vehicle 100c. The position of the magnets 126 relative to the conducting discs 116 is determined by controlling the actuators associated with each of the adjustable magnet holding brackets 163.

According to one embodiment, the control system executed by the computing device 166 facilitates an input of a desired wattage value by the rider. The control system obtains a signal from the power meter 129 that indicates the actual wattage applied by a rider to the human powered vehicle 100c at a given instant. The control system controls the positioning of the adjustable magnet holding brackets 163 to vary the force opposing the movement of the human powered vehicle 100c due to the eddy currents in the conducting discs 116 generated by the proximity of the magnets 126 to the conducting discs 116. In this manner, the control system can control the magnitude of the force opposing the movement of the human powered vehicle 100c at a given instant so that the wattage it takes to move the human powered vehicle 100c forward is as close as possible to the desired wattage value input by the rider.

During the operation of the human powered vehicle 100c, it may occur that the adjustable magnet holding bracket 163 reaches the maximum limit of its motion. That is to say, the control system executed by the computing device 166 may move the magnets 126 to a position such that the magnets 126 are the farthest away from or closest to the conducting disc 116. In such a circumstance, it may not be possible to maintain the desired wattage input by the rider.

In addition, in another embodiment, a wattage-per-distance record may be stored in a memory associated with the computing device 166 that specifies a desired wattage that changes over a given distance. Such wattage-per-distance records may emulate the wattage that would need to be expended, for example, over a race course or a section of a long race such as a portion of the Tour de France. In this manner, the computing device 166 can control the wattage it takes to operate the human powered vehicle 100c to simulate the terrain of a given course for purposes of training. This would be especially advantageous if the course upon which a rider trains is generally flat as compared to the course of the race for which one is training. It should be noted that the various systems and components discussed above with reference to FIGS. 1, 2, and 3 may be implemented along with other systems on the human powered vehicles 100a, 100b, and 100c. For example, such human powered vehicles 100a, 100b, and 100c may include gears, friction brakes, and other systems and structures.

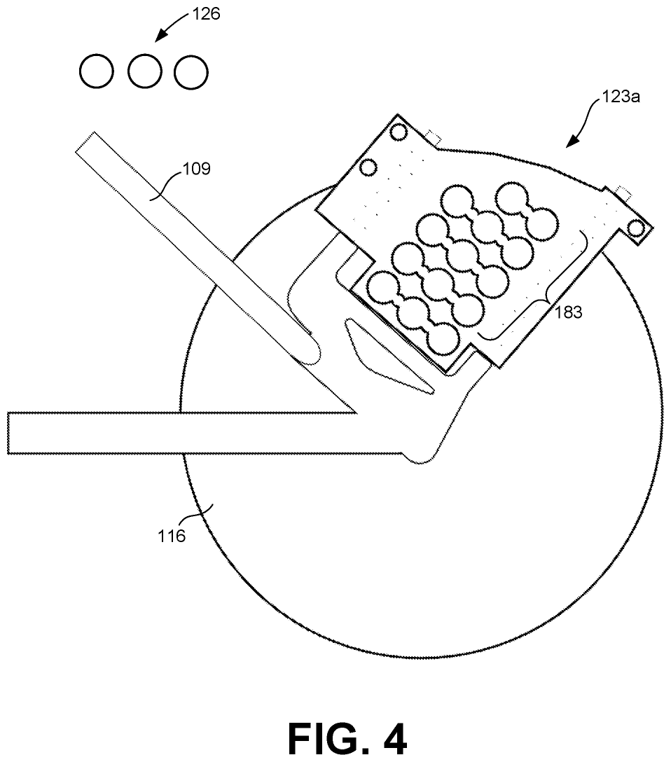

With reference to FIG. 4, shown is an example static magnet holding bracket 123, denoted herein as static magnet holding bracket 123a, that can be used to oppose movement of the human powered vehicle 100a (FIG. 1) according to an embodiment of the present disclosure. As shown, the static magnet holding bracket 123a is fixedly positioned relative to one of the conducting discs 116. According to various embodiments, the magnet holding bracket 123a includes one or more receptacles 183 that are configured to receive the one or more magnets 126. For example, the one or more magnets 126 can be inserted into the receptacles 183 and be exposed to one side of the conducting disc 116. Each of the receptacles 183 is shaped so that a magnet 126 will fit therein. To this end, each of the receptacles 183 may comprise, for example, a tapered recess, or a recess with projections or a stop that prevent a magnet 126 from passing through the receptacle 183. In one embodiment, each of the receptacles 183 may include a shelf that abuts with a projection on a magnet 126 when the magnet 126 is placed in the receptacle 183.

In one embodiment, the magnetic attraction between the material of the receptacle 183 and the magnet 126 holds the magnet 126 in the receptacle 183. Alternatively, the magnetic attraction between the material of the disc 116 and the magnet 126 holds the magnet 126 in the receptacle 183.

Although a circular shape is shown for the receptacles 183 to accommodate circular or spherical magnets 126, the receptacles 183 can include other suitable shapes to fit various magnet shapes, such as rectangular, cylindrical, bar shaped, horseshoe shaped, and other shapes. As discussed above, the magnets 126 can include permanent magnets or electromagnets. Permanent magnets that may be used include ceramic, alnico, samarium cobalt, neodymium iron boron, injection molded, and other types of permanent magnets.

In one embodiment, one or more magnets 126 may be placed in the respective receptacles 183 such that the number of receptacles 183 that include a magnet 126 may vary. In this manner, one may vary the force that opposes the movement of the human powered vehicle 100a by varying the number of magnets 126 placed into various receptacles 183. In addition, the force opposing the movement of the human powered vehicle 100a may vary based upon the placement of the magnets 126 relative to the conducting disc 116. That is to say, magnets 126 placed closer to the center of the conducting disc 116 will generate less force than magnets 126 placed closer to the outer rim of the disc 116. Thus, the magnitude of the force opposing the movement of the human powered vehicle 100a may vary based on the number of magnets 126 placed in the receptacles 183 and the position of the respective magnets 126 in respective receptacles 183 relative to the conducting disc 116.

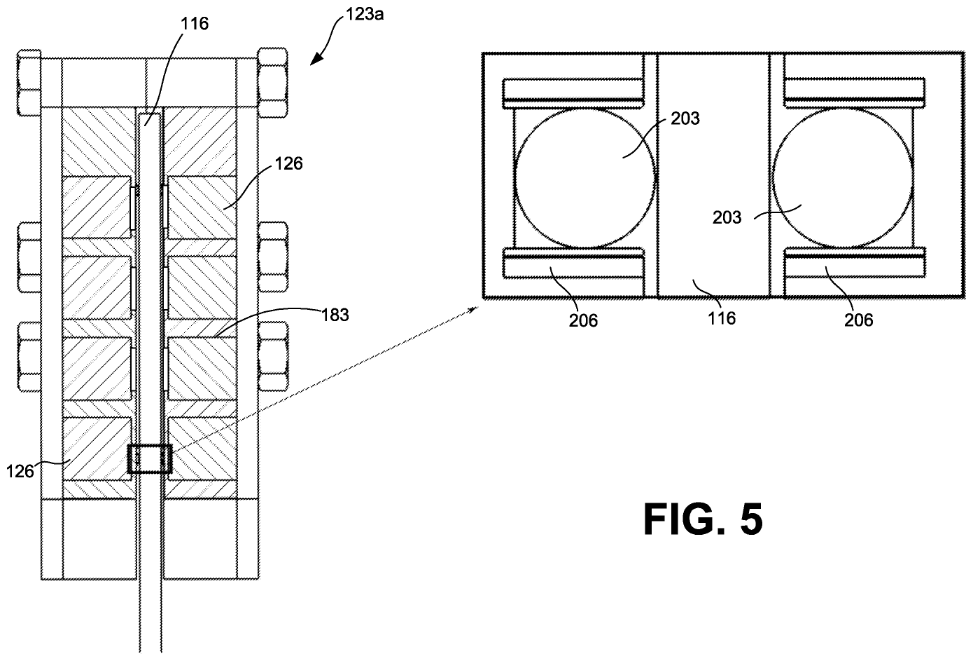

Turning to FIG. 5, shown is a side view of the static magnet holding bracket 123a that can be used to oppose movement of the human powered vehicle 100a (FIG. 1) according to an embodiment of the present disclosure. As shown, the static magnet holding bracket 123a incorporates a dual sided design such that the magnets 126 are placed within receptacles 183 are exposed to both sides of the conducting disc 116. FIG. 5 illustrates four of the magnets 126 positioned relative to one side of the conducting disc 116 and another four of the magnets 126 positioned relative to a second side of the conducting disc 116. In other embodiments, the static magnet holding bracket 123a can include more or less than four of the magnets 126 positioned relative to either side of the conducting disc 116. In another alternative, the static magnet holding bracket 123a may comprise a single sided design in which magnets 126 are positioned only on a single side of the conducting disc 116, where the static magnet holding bracket 123a includes only a single side. This approach may be desirable if clearance with other components of the wheel requires a single sided approach.

The static magnet holding bracket 123a further includes one or more bearings 203 positioned within sleeves 206. The bearings 203 are positioned adjacent to each of the magnets 126 to separate the static magnet holding bracket 123a from the conducting disc 116. Specifically, the bearings 203 separate the magnets 126 from the conducting disc 116. For example, without the bearings 203, the magnets 126 might make contact with the conducting disc 116, which would create unwanted friction between the magnets 126 and the conducting disc 116. To this end, the bearings 203 act to bring the magnets 126 as close as possible to the conducting disc 116 without creating physical contact between the magnets 126 and the conducting disc 116. This facilitates a magnetic field from the magnets 1126 with a higher density being incident to or exposed to the conducting disc 116 than if the magnets 126 were positioned further away from the conducting disc 116. In various embodiments, the bearings 203 can include ball bearings, roller bearings, and other types of bearings.

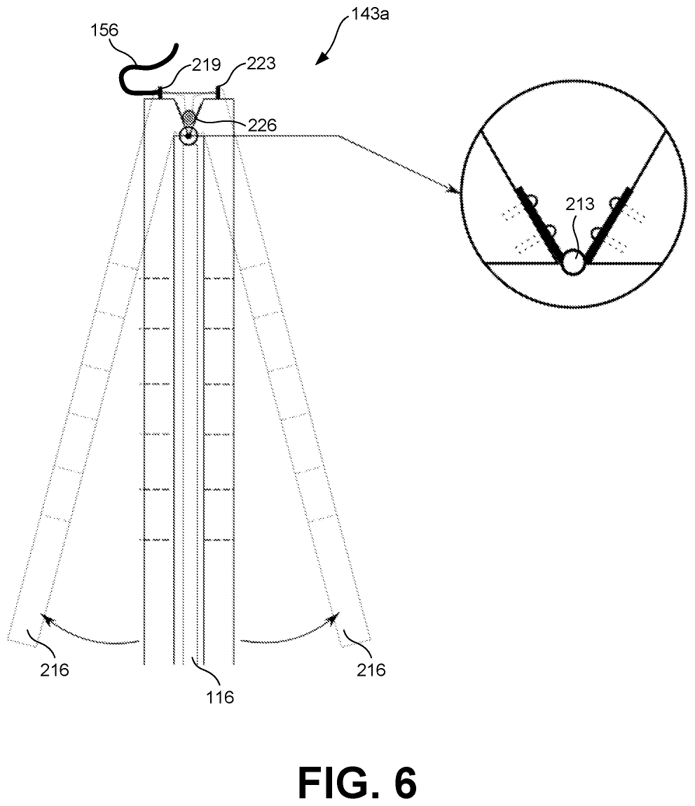

FIG. 6 illustrates an example adjustable magnet holding bracket 143a that can be used to oppose movement of the human powered vehicle 100b (FIG. 2) according to an embodiment of the present disclosure. The adjustable magnet holding bracket 143a is one example of the magnetic holding bracket 143 (FIG. 2).

The adjustable magnet holding bracket 143a comprises a clamshell configuration incorporating a hinge mechanism 213 and sides 216, where the sides 216 are positioned relative to the conducting disc 116. The sides 216 are configured to move toward or away from the conducting disc 116 based on a force generated by virtue of the cable 156 (FIG. 1). An outer jacket of the cable 156 abuts an attachment point 219 and the inner portion of the cable 156 is attached to a second attachment point 223. The attachment points 219 and 223 are couple to a respective one of the sides 216. The opposing end of the cable 156 is coupled to levers 153 (FIG. 2) as described above.

In another alternative, the adjustable magnet holding bracket 143a may comprise a single sided design in which magnets 126 are positioned only on a single side 216 of the conducting disc 116, where the adjustable magnet holding bracket 143a includes only a single side 216. This approach may be desirable if clearance with other components of the wheel requires a single sided approach.

A torsional spring 226 is positioned at the hinge point between the sides 216 to provide a force to pivot the sides 216 away from the conducting disc 116. The torsional spring 226 may be positioned to be coaxial relative to the hinge mechanism 213. Each of the pair of sides 216 include receptacles to hold the magnets 126 (FIG. 3). Also, a bearing 203 (FIG. 5) may be positioned on each of the sides 216 so as allow the sides 216 to come as close as possible to the conducting disc 116 while eliminating any friction between the sides 216 and the conducting disc 116 except for the friction that occurs due to the bearing 203 held in its receptacle or other bearing structure. As shown in FIG. 5, the bearing 203 comprises a ball bearing. However, it is understood that the bearing 203 may comprise any type of bearing such as, for example, cylindrical bearings, frictionless materials such as Teflon, or other types of bearing between the adjustable magnet holding bracket 143a and a conducting disc 116.

With implementation of the adjustable magnet holding bracket 143a, a rider of the human powered vehicle 100b can control the amount of force generated by virtue of eddy currents in the conducting discs 116 by positioning a respective lever 153. The positioning of the lever 153 causes the cable 156 to pull the attachment points 219 and 223 closer together, thereby causing the magnets 126 disposed in the sides 216 to move further away from the conducting disc 116. Alternatively, the lever 153 may be positioned such that the attachment points 219 and 223 are positioned farther apart, thereby allowing the magnets 126 disposed in the sides 216 to come closer to the conducting disc 116. In this manner the distance between the magnets 126 and the conducting disc 116 is varied, thereby varying the amount of force that results from the creation of eddy currents in the conducting disc 116. It should be noted that the adjustable magnet holding bracket 143a is positioned so as to avoid interference with other parts of a bicycle as can be appreciated.

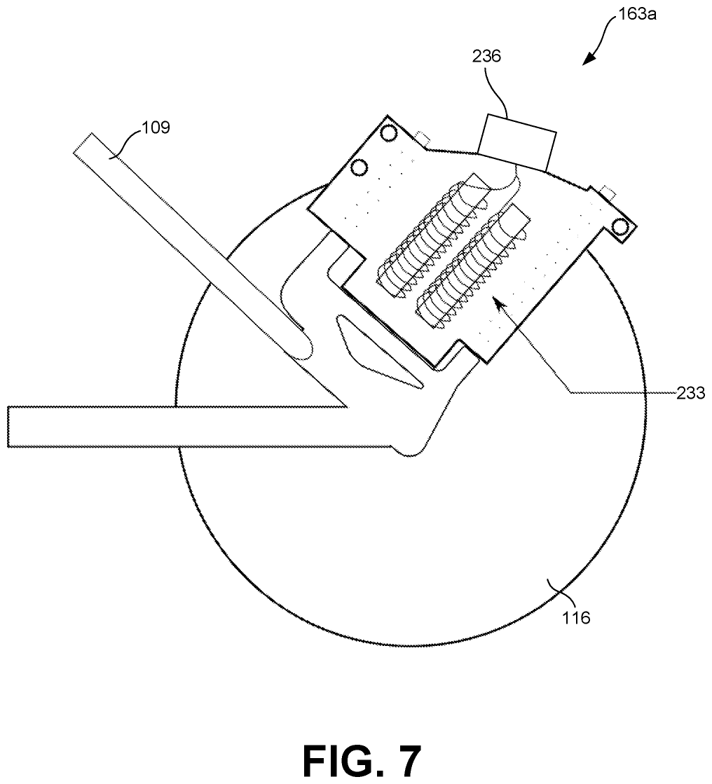

With reference next to FIG. 7, shown is an example of an adjustable magnet holding bracket 163 (FIG. 3) that is denoted herein as adjustable magnet holding bracket 163a. The adjustable magnet holding bracket 163a is used to oppose movement of the human powered vehicle 100c (FIG. 1) according to an embodiment of the present disclosure.

The adjustable magnet holding bracket 163a includes many of the same components as the static magnet holding bracket 163a (FIG. 4) except as set forth in the description below, where like components are denoted with the same reference numbers. The adjustable magnet holding bracket 163a further includes electromagnets 233 that are connected to a power source 236. The electromagnets 233 may comprise resistive electromagnets and other types of electromagnets. The power source 230 can include a direct current (DC) or alternating current (AC) voltage sources. According to various embodiments the power source 230 can include batteries, generators, solar cells, and other types of power sources.

In another alternative, the adjustable magnet holding bracket 163a may comprise a single sided design in which magnets 126 are positioned only on a single side of the conducting disc 116, where the adjustable magnet holding bracket 163a includes only a single side. This approach may be desirable if clearance with other components of the wheel requires a single sided approach.

The electromagnets 233 are attached to the adjustable magnet holding bracket 163a such that the magnetic field generated therefrom intersects or falls incident upon the conducting disc 116. In one embodiment, the electromagnets 233 are attached so as to be positioned and oriented in such a manner so as to maximize the magnetic flux of the magnetic field generated by the electromagnet 233 that falls incident to or intersects with the conducting disc 116 when the electromagnets 233 are operated at maximum setting thereby generating a magnetic field with the largest amount of magnetic flux possible.

The adjustable magnet holding bracket 163a is termed adjustable herein as the magnetic field generated by the electromagnets 233 is adjustable based on the magnitude of the electrical power or current applied to the electromagnets 233 from the power source 236 at a given moment. To this end, the computing device 166 (FIG. 3) may generate a signal that controls or throttles the amount of power that flows from the power source 236 to the electromagnets 233 at any given time. The signal generated by the computing device 166 may control the actual amount of power applied to the electromagnets 233 using various electrical techniques, or the computing device 166 may include power generation and control circuitry by which a current is generated that flows directly to the electromagnets 233. In the latter case, the power source 236 may be electrically coupled to the computing device 166 to generate such current as opposed to being connected to the electromagnets 233 as shown in FIG. 7.

Thus, adjustable magnet holding bracket 163a with the electromagnets 233 can generate a variable force that opposes the movement of the human powered vehicle 100c (FIG. 3). A rider is able to manually adjust the magnitude of such opposing force by controlling the current applied to the electromagnets 233 and thereby control the amount of wattage of opposing force generated thereby. Alternatively, a predefined program may be executed in the computing device 166 that automatically controls current applied to the electromagnets 233, thereby controlling the magnitude of the opposing force generated at a given instant as the human powered vehicle 100c travels as will be described in greater details with reference to later figures.

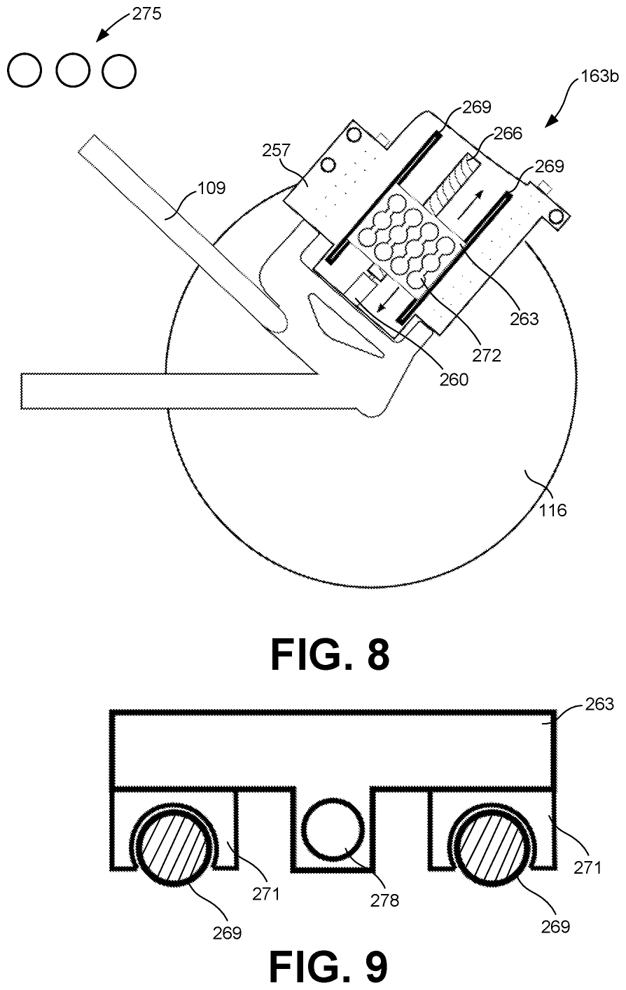

FIG. 8 illustrates an example adjustable magnet holding bracket 163b that can be used to oppose movement of the human powered vehicle 100c (FIG. 3) according to an embodiment of the present disclosure. The adjustable magnet holding bracket 163b is positioned relative to the conducting disc 116 and includes a base 243 that is fixedly connected to the frame 109 of the human powered vehicle 100c. Further, the adjustable magnet holding bracket 163b includes a movable tray 246 that can hold one or more magnets 126. To illustrate, the movable tray 246 includes receptacles 249 that can receive the one or more magnets 126. The one or more magnets 126 can include permanent magnets, electromagnets, and other types of magnets.

The movable tray 246 is configured to move along rails 253 by way of an actuator 256 and threaded shaft 266. The actuator 256, which is controlled by a control system (not shown) implemented in the computing device 166 (FIG. 3), can be configured to rotate a screw shaft 259 that causes the moveable tray 246 to move linearly along the rails 253. The moveable tray 246 includes a threaded hole through which the screw shaft 259 is threaded. The actuator 256 may comprise a motor, stepper motor, or other type of rotating element. As an alternative, rather than using the rails 253, the base 243 may include shaped grooves and the moveable tray 246 may include projections that fit into the shaped grooves that hold the moveable tray 246 to the base 243 and allow the moveable tray 246 to slide along the grooves. In either configuration, the moveable tray 246 moves in either direction along a linear axis as shown. In addition, it should be noted that the moveable tray 246 is positioned on the inside of the base 243 such that the magnets 126 in the moveable tray 246 are placed as close as possible to the conducting disc 116.

The adjustable magnet holding bracket 163b is adjustable in that the variable positioning of the magnets 126 relative to the conducting disc 116 varies the opposing force created by the eddy currents in the conducting disc 116. In this manner, the rider may specify a desired wattage that opposes the movement of the human powered vehicle 100c. To this end, the computing device 166 may generate a driving signal that is applied to the actuator 256 that rotates the screw shaft 259 to move the moveable tray 246 to a desired position such that the magnetic fields of more or less magnets 126 falls incident to the conducting disc 116, thereby generating a desired wattage that is born by the rider as they pedal or otherwise propel the human powered vehicle 100c. As shown the adjustable magnet holding bracket 163b comprises a single sided design in which magnets 126 are positioned only on a single side of the conducting disc 116. As an alternative, a double sided approach may be employed where the moveable tray 246 straddles two sides of the conducting disc 116.

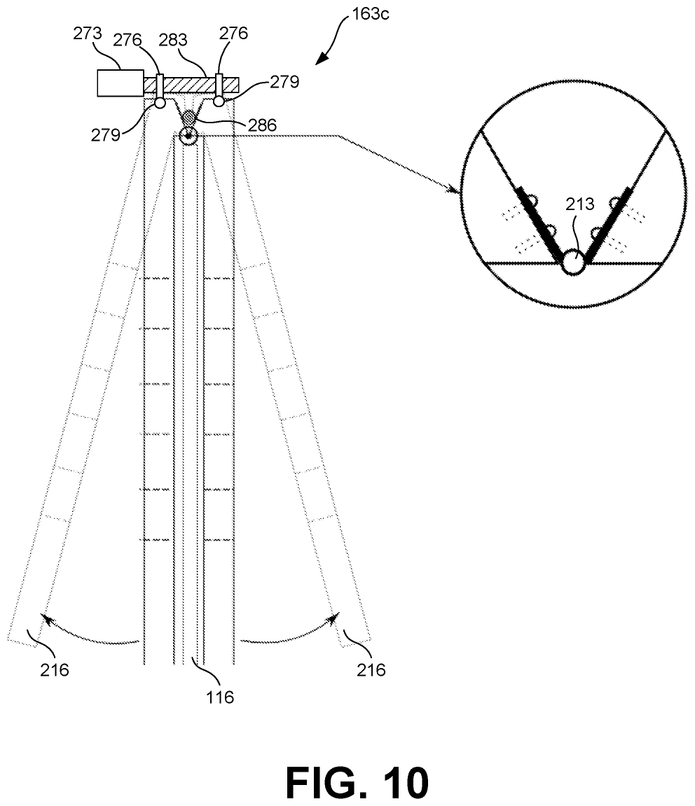

FIG. 9 illustrates a sectional view of the movable tray 246 that moves along the rails 253. The moveable tray 246 includes rail connectors 271 through which the rails 253 slide, thereby connecting the moveable tray 246 to the rails 253.

The movable tray 246 includes a threaded hole to accommodate the threaded shaft 259. As shown, the rails 253 comprise cylindrically shaped rods, but may also comprise rods of different shapes that facilitate motion of the moveable tray 246 as can be appreciated.

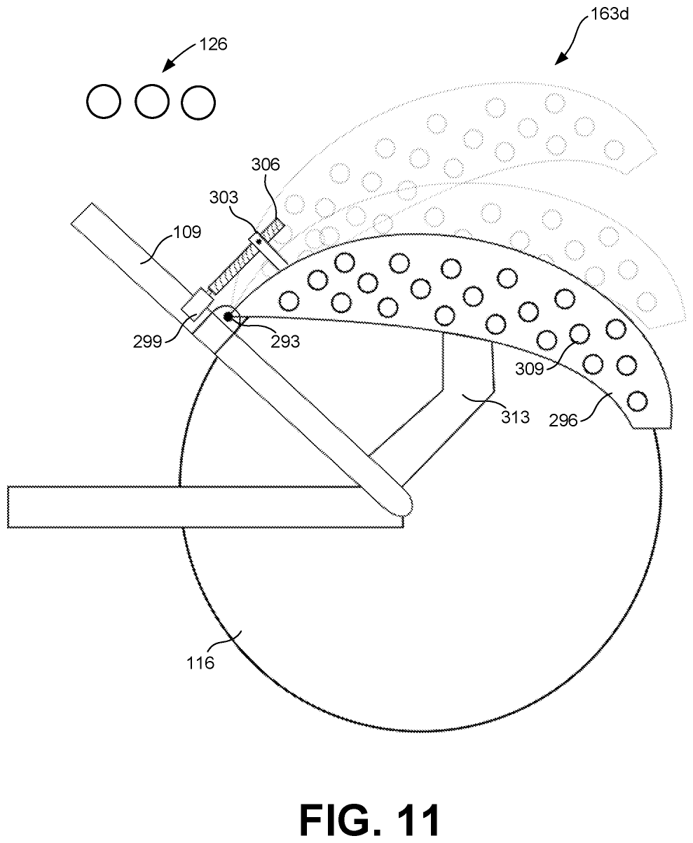

FIG. 10 illustrates an example adjustable magnet holding bracket 163c that can be used to oppose movement of the human powered vehicle 100c (FIG. 3) according to an embodiment of the present disclosure. The adjustable magnet holding bracket 163c includes a clamshell bracket incorporating a hinge mechanism 213 and is positioned relative to the conducting disc 116. The adjustable magnet holding bracket 163c further includes a pair of sides 216 that are configured to be drawn toward or away from the conducting disc 116 based on an actuating force applied by actuator 273. The actuator 273 may comprise, for example, a motor, stepper motor, or other actuator. The actuator 273 connects to the pair of sides 216 through movable extensions 276 that are connected to the sides by way of pivot points 279. A screw shaft 283 is positioned though threaded holds in the moveable extensions 276. Each of the sides 216 include receptacles to hold the magnets 126 (FIG. 3).

In another alternative, the adjustable magnet holding bracket 163c may comprise a single sided design in which magnets 126 are positioned only on a single side of the conducting disc 116, where the adjustable magnet holding bracket 163b includes only a single side. This approach may be desirable if clearance with other components of the wheel requires a single sided approach.

The actuator 273 is controlled by a control system (not shown) implemented by way of the computing device 166 (FIG. 3). The actuator 273 can be configured to rotate the threaded shaft 312, thereby causing the sides 216 to move toward or away from the conducting disc 116. In this manner, the magnets 126 may be positioned either closer to or further away from the conducting disc 116. This relative positioning of the magnets 126 and the conducing disc 116 creates a greater or lesser amount of force opposing the movement of the human powered vehicle 100c. As the pair of sides 216 are drawn closer to the conducting disc 116, the magnets 126 apply a denser magnetic field to the conducting disc 116, thereby applying a greater opposing force against the movement of the human powered vehicle 100c. In one embodiment, when the threaded shaft 312 is rotated in a given direction, a torsional spring 286 helps facilitate the drawing motion of the pair of sides 216.

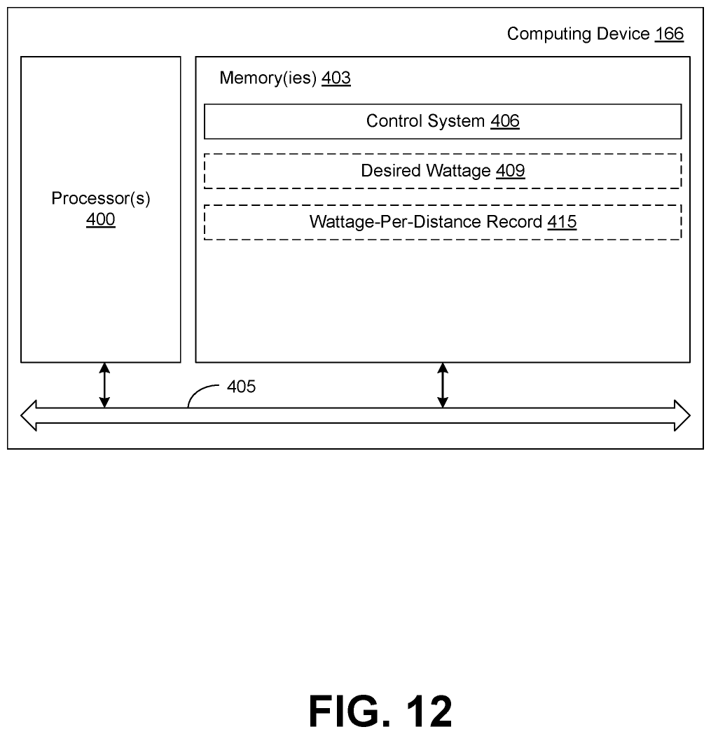

FIG. 11 illustrates an example adjustable magnet holding bracket 163d that can be used to oppose movement of the human powered vehicle 100c (FIG. 3) according to an embodiment of the present disclosure. The adjustable magnet holding bracket 163d includes a hinge mechanism 293 that facilitates its movement. The adjustable magnet holding bracket 163d is a pivoting fender structure 296 with two sides that can be configured to be drawn toward or away from the conducting disc 116 based on an actuating force applied by an actuator 299. When the adjustable magnet holding bracket 163d is drawn toward the conducting disc 116, the pivoting fender structure 296 can completely cover a portion of the conducting disc 116 as can be appreciated. To this end, the pivoting fender structure 296 includes two sides that straddle the conducting disc 116 when the adjustable magnet holding bracket 163d partially or fully engaged. The pivoting fender structure 296 pivots about a pivot point of the hinge mechanism 293.

The adjustable magnet holding bracket 163d further includes an attachment extension 303 that includes a threaded hole that accommodates a threaded shaft 306. In this manner, the attachment extension 303 is configured to pivot as the pivoting fender structure 296 is raised or lowered by the rotation of the threaded shaft 306. Further, the adjustable magnet holding bracket 163d includes receptacles 309 into which the magnets 126 are positioned. As shown, the adjustable magnet holding bracket 163d includes the receptacles 309 on one side. However, in various embodiments, the adjustable magnet holding bracket 163d includes the receptacles 309 on both sides such that the magnetic fields from magnets 126 disposed in the receptacles fall incident to the conducting disc 116 when the pivoting fender structure 296 is partially or fully engaged with the conducting disc 116.

During operation, the actuator 299 is controlled by a control system (not shown) implemented in the computing device 166 (FIG. 3). The actuator 299 can be configured to rotate the threaded shaft 306, thereby causing the pivoting fender structure 296 to move toward a portion of the conducting disc 116 where the sides of the pivoting fender structure 296 straddle the conducting disc 116. Conversely, the actuator 299 may rotate the threaded shaft 306 in the opposite direction, thereby retracting the pivoting fender structure 296 away from the conducting disc 116. The adjustable magnet holding bracket 163d includes a stop 313 at the maximum limit of motion of the pivoting fender structure 296 toward the conducting disc 116. To this end, the stop 313 can prevent the pivoting fender structure 296 from physically contacting the conducting disc 116.

In another alternative, the pivoting fender structure 296 may comprises a single sided design in which magnets 126 are positioned only on a single side of the conducting disc 116, where the pivoting fender structure 296 includes only a single side. This approach may be desirable if clearance with other components of the wheel requires a single sided approach.

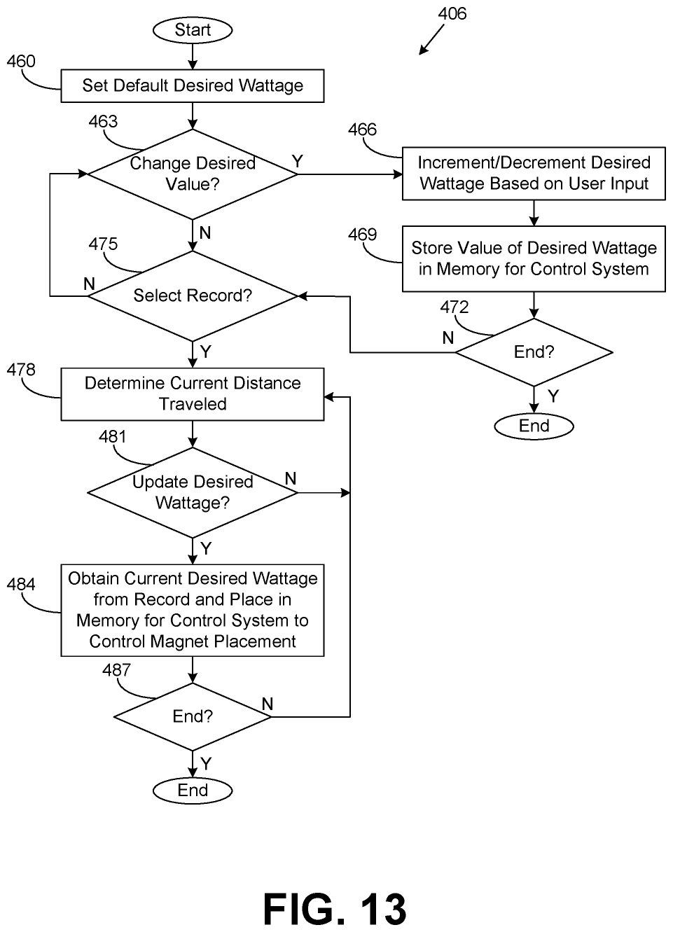

With reference to FIG. 12, shown is a schematic block diagram of the computing device 166 implemented in the human powered vehicle 100c (FIG. 3) according to various embodiments of the present disclosure. Various applications and/or other functionality may be executed in the computing device 166 according to various embodiments. Also, various data is stored in a memory 403 that is accessible to the computing device 166. The memory 403 may be representative of a plurality of memories 403 as can be appreciated. The data stored in the memory 403, for example, is associated with the operation of the various applications and/or functional entities described below.

The computing device 166 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, head mounted displays, voice interface devices, or other devices. The computing device 166 may include a display. The display may comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The computing device 166 includes at least one processor circuit, for example, having a processor 400 and the memory 403, both of which are coupled to a local interface 405. To this end, the computing device 166 may comprise, for example, at least one server computer or like device. The local interface 405 may comprise, for example, a data bus with an accompanying address/control bus or other bus structure as can be appreciated.

Stored in the memory 403 are both data and several components that are executable by the processor 400. In particular, stored in the memory 403 and executable by the processor 400 is a control system 406, and potentially other systems and/or applications. Also stored in the memory 403 may be desired wattage 409, wattage-per-distance record 415, and other data. In addition, an operating system may be stored in the memory 403 and executable by the processor 400.

In various embodiments, the control system 406 facilitates the movement of the adjustable magnet holding brackets 163 based on a differential between the desired wattage 409 inputted by a rider and the actual wattage collected by the power meter 129 (FIG. 3). For example, the control system 406 operates to adjust the positioning of the magnets 126 relative to the conducting discs 116 to maintain a desired wattage 409 entered by a rider as the rider propels the human powered vehicle 100c.

In other embodiments, the control system 406 facilitates the movement of the adjustable magnet holding brackets 163 based on a differential between wattage values stored in the wattage-per-distance record 415 and the actual wattage collected by the power meter 129 over a distance traveled. Such wattage-per-distance records 415 may emulate the wattage that would need to be expended, for example, over a race course or a section of a long race such as a portion of the Tour de France based on actual wattage measurements taken from such courses given factors such as the weight of the bicycle and rider and potentially other factors. As a rider propels the human powered vehicle 100c, the control system 406 operates to adjust the positioning of the magnets 126 so that the actual wattage sensed by the power meter 129 over a distance traveled approximately equals the wattage values stored in the wattage-per-distance record 415 implemented on the computing device 166.

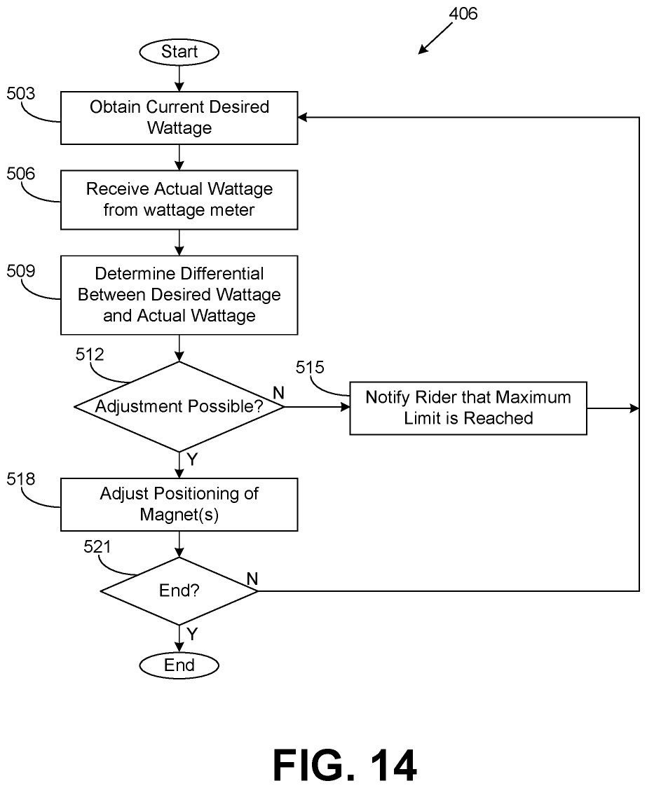

With reference to FIG. 13, shown is a flowchart that provides one example of the operation of a portion of the control system 406 according to various embodiments. To this end, the flowchart of FIG. 13 sets forth functionality of the control system 406 in determining a current desired wattage that is used to adjust the positioning of the magnets 126 relative to the conducting discs 116. The current desired wattage may be entered by a rider or it may be taken from a wattage-per-distance record 415 (FIG. 12) as will be discussed. It is understood that the flowchart of FIG. 13 provides merely an example of the many different types of functional arrangements that may be employed to implement the operation of the portion of the control system 406 as described herein. As an alternative, the flowchart of FIG. 13 may be viewed as depicting an example of elements of a method implemented in the computing device 166 (FIG. 12) according to one or more embodiments.

Beginning with box 460, the control system 406 initializes its operation and sets a default desired wattage 409 (FIG. 12). The default desired wattage 409 may be set at zero or some other value that is maintained until changed by a user. As a result, whenever the rider first begins operating the human powered vehicle 100c and activates the control system 406, the control system 406 will set the default desired wattage 409 to zero. Thereafter, the control system 406 will allow the user to change the desired wattage 409 or select a file from the wattage-per-distance record 415 as will be described.

Next, in box 463, the control system 406 determines whether an input has occurred indicating whether the current desired wattage 409 is to be changed. Such would be the case if a user manipulates an input device associated with the computing device 166 to enter a value of the desired wattage 409, or to increment or decrement the desired wattage 409.

Alternatively, the desired wattage 409 may be adjusted based on metrics that vary over time. For example, the pulse of the rider may be obtained from a sensor and the desired wattage 409 may be specified to maintain a desired range of pulse rate of the rider. Other metrics that can be measured include the speed of the rider, the time the rider has been propelling the human powered vehicle 100 assuming they might get tired over time, and other metrics.

Assuming the current desired wattage 409 is to be changed, the control system 406 proceeds to box 466. Otherwise, the control system 406 proceeds to box 475.

In box 466, the control system 406 increments, decrements, otherwise changes the desired wattage 409 based on the rider's input. Such an input may comprise, for example, pressing an arrow key that indicates that the desired wattage 409 should be increased or decreased by a predetermined amount, or a user input may simply specify a new value to be used for the desired wattage 409. For example, over the course of a ride, the rider may want to increase/decrease the desired wattage value based on terrain, conditioning of the rider, to maintain a higher wattage output while increasing/decreasing velocity, and other factors. Thereafter, the control system proceeds to box 469.

In box 469, the control system 406 stores the current desired wattage 409 in the memory 403 so that the control system 406 can attempt to maintain the corresponding wattage value by adjusting the positioning of the magnets 126 placed within the adjustable magnet holding brackets 163 as mentioned above.

Next, the control system moves to box 472 in which the control system 406 determines whether to terminate based on user input or by virtue of the fact that the human powered vehicle 100c has stopped movement altogether for a predefined period of time. For example, the rider may have reached the intended destination and stopped propelling the human powered vehicle 100c and placed it in a storage space such as a garage or a bicycle rack. In another scenario, the rider may not want any added resistance during a segment of a ride and may terminate the control system 406 based on an interaction with a user interface on a display of the computing device 166. Assuming that no circumstance exists such that the functionality of the control system 406 is to cease, the control system 406 proceeds to box 475. Otherwise, the operation of the control system 406 ends as shown.

In box 475, the control system 406 determines whether a selection of a wattage-per-distance record 415 has been made by a user. To this end, the computing device 166 may include various user interface components that allow a user to select a wattage-per-distance record 415 if desired. Such wattage-per-distance records may emulate the wattage that would need to be expended, for example, over a race course or a section of a long race such as a portion of the Tour de France as described above. If the rider chooses to select a file from the wattage-per-distance record, the control system proceeds to box 478. If the rider does not choose to select a file from the wattage-per-distance record, the control system 406 reverts back to box 463. Thus, the control system 406 remains in a loop at boxes 463 and 475 until a user manipulates the computing device 166 as described above.

In box 478, the current distance traveled after a wattage-per-distance record 415 is selected is determined by the control system 406. For example, the control system 406 can include a distance tracker that tracks the distance traveled by the human powered vehicle 100c. In various embodiments, the control system 406 can incorporate a global positioning system (GPS) to track the distance traveled. The current distance traveled and the actual wattage readings received by the control system 406 over the current distance tracked can be compared to wattage values stored in a selected wattage-per-distance record 415. For example, a selected wattage-per-distance record 415 includes wattage values to be maintained by the control system 406 as desired wattage 409 values at certain distance intervals. Once the current distance traveled by the human powered vehicle 100c meets a distance interval necessitating a wattage value change specified by the selected wattage-per-distance record 415, the desired wattage 409 is automatically updated in the memory to the wattage value specified in the selected wattage-per-distance record 415.

In an additional embodiment, the distance interval between desired wattages 409 in a given wattage-per-distance record 415 may be so small as to be effectively continuous. In such a manner, the control system 406 may examine the current value of the desired wattage from the wattage-per-distance record 415 each time the control system 406 reaches box 481. In one embodiment, a delay may be imposed before the control system 406 reaches box 481 if it is desired to throttle the variation in the desired wattages 409 received from the wattage-per-distance record 415.

Next, the control system 406 moves to box 481. In box 481, the control system determines whether to update the desired wattage 409 based on the wattage-per-distance record 415 selected and the current distance traveled by the human powered vehicle 100c. As explained above, if the human powered vehicle 100c has traveled far enough to meet a next distance interval point necessitating a desired wattage 409 value change specified by the selected wattage-per-distance record 415, the control system 406 moves to box 484. If the human powered vehicle 100c has not yet traveled far enough, the control system 406 revers to box 478.

In box 484, the control system 406 updates the desired wattage value 409 in the memory 403 (FIG. 12) to a current wattage value specified in the selected wattage-per-distance record 415. For example, the wattage-per-distance record 415 selected may emulate a section of a race in which for the first 500 meters, the wattage to be maintained is 100 watts, and for the next 500 meters, the wattage to be maintained is 125 watts. As explained above, based on the current distance traveled that is determined in box 478, if the human powered vehicle 100c has moved 500 meters, the control system 406 can update the desired wattage 409 in the memory 403 from 100 watts to 125 watts. To this end, the control system 406 will attempt to control the positioning of the magnets 126 placed in the adjustable magnet holding brackets 163 depending on the actual wattage readings received from the power meter 129 so that the total wattage consumed is as close as possible to the desired wattage 409 at any given time given that the terrain over which the human powered vehicle 100c may vary as well.

Next, the control system 406 proceeds to box 487. In box 487, the control system 406 can determine whether execution of the control system 406 is to be terminated based on user input or that the human powered vehicle 100c has reached a final destination point as specified by the selected wattage-per-distance record 415, or based on some other criteria. For the case of user input, the rider may have reached the intended destination and stopped the human powered vehicle 100c from moving altogether. Alternatively, a termination condition may be that the human powered vehicle 100c has not moved for a predefined period of time. In another case, the rider may terminate the control system 406 prematurely before finishing out the segment specified in the wattage-per-distance record by manipulating elements of a user interface on the computing device 166. If the control system 406 has not reached an ending point in box 487, then the control system 406 reverts to box 478 as shown. Otherwise, the control system 406 ends as shown.

With reference to FIG. 14, shown is a flowchart that provides an example of the operation of an additional portion of the control system 406 according to various embodiments. To this end, the flowchart of FIG. 14 exemplifies an adjustment process the control system 406 implemented to control the positioning of the magnets 126 (FIGS. 7-11) based on the desired wattage 409 stored in the memory 403 at any given moment. It is understood that the flowchart of FIG. 14 provides merely an example of the many different types of functional arrangements that may be employed to implement the operation of this portion of the control system 406 as described herein. As an alternative, the flowchart of FIG. 14 may be viewed as depicting an example of elements of a method implemented in the computing device 166 (FIG. 12) according to one or more embodiments.

Beginning with box 503, the control system 406 obtains a current desired wattage 409 from the memory 403. The desired wattage 409 may be manually entered by a user or taken from a wattage-per-distance record 415 as described above.

Next, the control system 406 proceeds to box 506 in which the control system 406 receives the actual wattage consumed from the power meter 129 (FIG. 3) as the rider propels the human powered vehicle 100c. The actual wattage value from the power meter 129 indicates an exertion level or total power expended by the rider as the human powered vehicle is moved.

Thereafter, the control system 406 proceeds to box 509 in which the control system 406 determines a differential between the current desired wattage 409 and the actual wattage being expended by the rider as the human powered vehicle 100c is propelled by the rider. In some scenarios, there may not be a differential if the rider is expending an actual wattage that is similar to the current desired wattage 409.

Then, in box 512 the control system 406 determines whether an adjustment of the positioning of the magnets 126 is possible to match the actual wattage values to the desired wattage 409. In some scenarios, the adjustable magnet holding bracket 163 can reach the maximum limit of its motion. That is to say, the control system 406 executed by the computing device 166 may move the magnets 126 to a position such that the magnets 126 are the farthest away from, or closest to, the conducting disc 116. For example, during the course of a ride, the rider may transition from a flat terrain to a hilly terrain. When riding on the hilly terrain, it may not be possible to maintain the desired wattage 409 input by the rider as the actual wattage being expended could far exceed the desired wattage 409 even with the magnets 126 positioned as far away from the conducting disc 116 as possible. If in box 512 adjustment is not possible, the control system 406 proceeds to box 515. If adjustment is possible, the control system 406 proceeds to box 518.

In box 515, the control system 406 notifies the rider that the adjustable magnet holding bracket 163 has reached the maximum limit of its motion. The rider can be notified by virtue of a banner or other output displayed on a user interface presented on a display of the computing device 166. In other embodiments, the rider can be notified through a handheld device or a watch that is in wireless communication with the computing device 166. The handheld device or watch can be communicatively coupled to the computing device 166 through WiFi, Bluetooth®, near-field communication (NFC), radio-frequency identification (RFID), wireless infrared, ultra-wideband, wireless induction, long range (LoRa), Z-Wave®, ZigBee®, and other wireless communication methods. Note that notification may also occur in some other manner such as haptic feedback on a watch or other device. After notifying the rider in box 515, the control system 406 reverts back to box 503.

Assuming the control system 406 proceeds to box 518, the control system 406 adjusts the positioning of the magnets 126 so that the actual wattage consumed comes as close as possible to, or matches, the desired wattage 409. In this manner, the control system 406 adjusts the positioning of the magnets 126 so as to minimize or eliminate any differential between the actual wattage consumed and the desired wattage 409.

To achieve this, the control system 406 drives the one or more actuators 260 (FIG. 8), 309 (FIG. 10), or 366 (FIG. 11) to adjust the positioning of the adjustable magnet holding brackets 163. Alternatively, the control system 406 may adjust the power applied to the electromagnets 233 (FIG. 7) accordingly. By adjusting the positioning of the magnet holding brackets 163a-d, the positioning of the magnets 126 placed in the magnet holding brackets 163a-d can be moved closer to or further away from the conducting disc 116. When the positioning of the magnets 126 are moved closer to the conducting disc 116, the magnitude of the magnetic flux of the magnets 126 that intersect with conducting disc 116 increases. Conversely, as the one or more magnets 126 are moved away from a side of a given conducting disc 116, the magnitude of the magnetic flux of the magnet 126 that intersects with the conducting disc 116 decreases. By adjusting the power applied to the electromagnets 233, the magnitude of the magnetic flux that falls incident upon the conducting disc 116 is increased or decreased accordingly.

As a rider rides the human powered vehicle 100c, the conducting discs 116 rotate, and eddy currents are induced in the conducting discs 116 by way of electromagnetic induction given that the magnetic fields of the magnets intersect with the conducting discs 116. The eddy currents produce a counter electromagnetic field that opposes the magnetic field of the magnets 126. As a result, the conducting discs 116 experience a drag force from the magnets 126 that opposes their rotation. The magnitude of the force that opposes the rotation of the conducting discs 116 depends on the size of the conducting disc 116, the number of magnets or magnitude of the magnetic flux that intersects with the conducting disc 116, the positioning of the magnets 126 relative to the conducting disc 116, the rotational velocity of the conducting disc 116, and on other factors.

Accordingly, the eddy currents produced on the conducting discs 116 oppose rotation of the wheels 103 and, correspondingly, increase the resistance experienced by a rider of the human powered vehicle 100c, thereby making pedaling more difficult for the rider.

In box 521, the control system 406 determines whether to terminate based on user input or by virtue of the fact that the human powered vehicle 100c has stopped movement altogether for a predefined period of time. For example, the rider may have reached the intended destination and stopped propelling the human powered vehicle 100c and placed it in a storage space such as a garage or a bicycle rack. In another scenario, the rider may not want any added resistance during a segment of a ride and may terminate the control system 406 based on an interaction with a user interface on a display of the computing device 166. Assuming that no circumstance exists such that the functionality of the control system 406 is to cease, the control system 406 reverts back to box 503 as shown. Otherwise, the operation of the control system 406 ends as shown.

In another embodiment, a delay may be imposed between box 521 and box 503 that may vary depending on how large a differential is determined between the desired wattage and the actual wattage in box 509. If the differential is greater, then such a delay may be reduced. Conversely, if the differential is smaller, then the delay may be increased. This would increase the responsiveness of the system when a larger differential is identified so that the system will react to cause the actual wattage to approach the desired wattage more quickly when needed. Stated another way, the frequency by which the control system 406 traverses the boxes of the flow chart of FIG. 14 would increase or decrease accordingly.

It is understood that there may be other applications that are stored in the memory 403 and are executable by the processor 400 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 403 and are executable by the processor 400. In this respect, the term “executable” means a program file that is in a form that can ultimately be run by the processor 400. Examples of executable programs may be, for example, a compiled program that can be translated into machine code in a format that can be loaded into a random access portion of the memory 403 and run by the processor 400, source code that may be expressed in proper format such as object code that is capable of being loaded into a random access portion of the memory 403 and executed by the processor 400, or source code that may be interpreted by another executable program to generate instructions in a random access portion of the memory 403 to be executed by the processor 400, etc. An executable program may be stored in any portion or component of the memory 403 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 403 is defined herein as including both volatile and nonvolatile memory and data storage components. Volatile components are those that do not retain data values upon loss of power. Nonvolatile components are those that retain data upon a loss of power. Thus, the memory 403 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 400 may represent multiple processors 400 and/or multiple processor cores and the memory 403 may represent multiple memories 403 that operate in parallel processing circuits, respectively. In such a case, the local interface 405 may be an appropriate network that facilitates communication between any two of the multiple processors 400, between any processor 400 and any of the memories 403, or between any two of the memories 403, etc. The local interface 405 may comprise additional systems designed to coordinate this communication, including, for example, performing load balancing. The processor 400 may be of electrical or of some other available construction.

Although the control system 406 and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 13 and 14 show the functionality and operation of an implementation of portions of the control system 406. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as the processor 400 in a computer system or other system. The machine code may be converted from the source code, etc. If embodied in hardware, each block may represent a circuit or a number of interconnected circuits to implement the specified logical function(s).

Although the flowcharts of FIGS. 13 and 14 shows a specific order of execution, it is understood that the order of execution may differ from that which is depicted. For example, the order of execution of two or more blocks may be scrambled relative to the order shown. Also, two or more blocks shown in succession in FIGS. 13 and 14 may be executed concurrently or with partial concurrence. Further, in some embodiments, one or more of the blocks shown in FIGS. 13 and 14 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the control system 406 that comprises software or code can be embodied in any non-transitory computer-readable medium for use by or in connection with an instruction execution system such as, for example, a processor 400 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Disjunctive language, such as the phrase “at least one of X, Y, or Z,” unless specifically stated otherwise, is to be understood with the context as used in general to present that an item, term, etc., can be either X, Y, or Z, or any combination thereof (e.g., X, Y, and/or Z). Thus, such disjunctive language is not generally intended to, and should not, imply that certain embodiments require at least one of X, at least one of Y, or at least one of Z to be each present.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Therefore, at least the following is claimed:

1. An apparatus, comprising:
a wheel attached to a frame of a human powered vehicle;
a conducting disc attached to the wheel, the conducting disc configured to rotate about a rotational axis of the wheel;
a magnet holding bracket attached to the frame of the human powered vehicle, the magnet holding bracket configured to hold at least one magnet, the magnet holding bracket being positioned relative to the conducting disc, wherein the conducting disc intersects with a magnetic field extending from at least one magnet; and
a controller configured to input a desired wattage to be maintained by the human powered vehicle, the controller adjusting a positioning of the at least one magnet based at least in part on the desired wattage.

2. The apparatus of claim 1, wherein the at least one magnet comprises a permanent magnet.

3. The apparatus of claim 1, wherein the at least one magnet comprises an electromagnet coupled to a power source.

4. The apparatus of claim 1, wherein at least one bearing separates the magnet holding bracket from the conducting disc.

5. The apparatus of claim 3, wherein the at least one bearing comprises at least one ball bearing.

6. The apparatus of claim 1, wherein the magnet holding bracket is adjustable.

7. The apparatus of claim 6, further comprising a stop connected to the frame, the stop limiting a movement of the magnet holding bracket relative to the conducting disc.

8. The apparatus of claim 6, wherein the magnet holding bracket comprises a movable tray that moves along an axis, wherein the movable tray comprises at least one receptacle to hold the at least one magnet.

9. The apparatus of claim 8, further comprising an actuator connected to a shaft, wherein the movable tray is attached to the shaft, the actuator being configured to move the movable tray along the axis.

10. The apparatus of claim 6, wherein the magnet holding bracket comprises a clamshell bracket, the clamshell bracket comprising a pair of sides connected by a hinge mechanism, where the conducting disc is located between the sides, wherein each of the sides is configured to pivot toward or away from the conducting disc.

11. The apparatus of claim 6, wherein the adjustable magnet holding bracket comprises a pivoting fender structure connected to a hinge mechanism, the pivoting fender structure being configured to pivot toward or away from the conducting disc, the pivoting fender structure being configured to cover a portion of the conducting disc when at least partially engaged with the conducting disc.

12. An apparatus, comprising:
a wheel attached to a frame of a human powered vehicle;
a conducting disc attached to the wheel, the conducting disc configured to rotate along with the wheel about a rotational axis of the wheel; and
a magnet holding bracket attached to the frame of the human powered vehicle, the magnet holding bracket configured to hold at least one magnet, the magnet holding bracket being positioned relative to the conducting disc, wherein the conducting disc intersects a magnetic field of the at least one magnet.

13. The apparatus of claim 12, wherein the magnet holding bracket comprises at least one receptacle to hold the at least one magnet.

14. The apparatus of claim 12, wherein at least one bearing separates the magnet holding bracket from the conducting disc.

15. The apparatus of claim 12, further comprising a controller configured to input a desired wattage to be maintained by the human powered vehicle, the controller adjusting a positioning of the at least one magnet based at least in part on the desired wattage.

16. The apparatus of claim 12, wherein the magnet holding bracket is stationary.

17. The apparatus of claim 12, wherein a position of the at least one magnet may be varied relative to the conducting disc.

18. The apparatus of claim 12, wherein the magnet holding bracket comprises a first side and a second side, the first side being positioned relative to a first side of the conducting disc, and the second side being positioned relative to a second side of the conducting disc, wherein the first side and the second side each include at least one receptacle to hold the at least one magnet.

19. A system, comprising:
a computing device comprising a processor and a memory; and
at least one processor circuit with a memory comprising instructions, that when executed by the processor circuit, causes the at least one processor circuit to at least:
receive an actual wattage from a power meter attached to the human powered vehicle, the actual wattage corresponding to an exertion output value expended by a rider during movement of the human powered vehicle;
determine a differential between a desired wattage and the actual wattage; and
adjusting a position of at least one magnet in a magnet relative to a conducting disc to minimize the differential, the conducting disc being configured to rotate about a rotational axis of a wheel attached to a frame of the human powered vehicle.

20. The system of claim 19, wherein the desired wattage is obtained from a plurality of wattage values stored in a wattage-per-distance record.
